(19) United States
(12) Patent Application Publication
(10) Pub. No.: US 2005/0046120 A1
(43) Pub. Date: Mar. 3, 2005

(54) Sealing gasket with flexible stopper

(76) Inventors: Martin Novil, Northville, MI (US); Yingjie Kong, Canton, MI (US); Scott M. Anderson, Canton, MI (US); Ronald W. Wangerow, Novi, MI (US)

Correspondence Address: FREUDENBERG-NOK GENERAL PARTNERSHIP;INTELLECTUAL PROPERTY DEPT., 47690 EAST ANCHOR COURT, PLYMOUTH, MI, 48170-2455, US

(21) Appl. No.: 10/650,339

(22) Filed: Aug. 28, 2003

(51) Int. Cl. F02F 11/00

(52) U.S. Cl. 277/592

(57) ABSTRACT

A sealing gasket includes an offset flexible stopper portion spaced laterally outwardly away from an offset inner sealing portion that is adjacent an opening or other area requiring sealing between mating members adapted to be clamped together. Preferably the gasket includes a single layer carrier onto which a resilient sealing material is applied to at least portions of the carrier, such as by screen printing, for example. The gasket can be used advantageously in sealing applications such as those for cylinder heads and blocks, intake or exhaust manifolds, piping or other fluid conveying devices, housings, enclosures, or other situations where relative movement can occur between the members to be sealed to each other.

### BACKGROUND AND SUMMARY OF THE INVENTION

The invention relates to a gasket for sealing between opposed mating surfaces of two or more members adapted to be forcibly mated together and to clamp the sealing gasket therebetween. More particularly, in a preferred form, the invention relates to such gaskets preferably having a single-layer carrier with unique embossments and a flexible stopper portion.

Conventional gaskets, such as those used to seal between a cylinder head and cylinder block of an internal combustion engine, include two or more carrier members, such as those composed of spring steel, having various embossments to achieve proper sealing as well as the recovery needed to accommodate dynamic lifting of the cylinder head or other relative movement between the head and block. Such gaskets frequently include a stopper, which is an additional thin strip of metal or other material having a high stiffness. The stopper is located adjacent or near the combustion opening of the gasket in order to distribute sufficient load around the combustion opening area to properly seal and to prevent over-compression of adjacent combustion sealing embossments. In such constructions, the stopper is typically welded onto the carrier or formed from a folded-over portion of the carrier around the circumference of the combustion opening. In these designs, the stopper acts as the primary seal, with one or more other embossments acting as a secondary seal.

Although performing relatively well, such prior art constructions often suffer from certain disadvantages caused by the high rigidity of the stopper, such as high bore distortion, cylinder liner recessing, and inadequate accommodation of dynamic head lifting. Such disadvantages are frequently aggravated by the location of such highly rigid stoppers at or closely adjacent the combustion opening of the gasket, the cylinder head and the cylinder block.

In order to improve upon such gasket designs and to address the disadvantages of gaskets of the type discussed above, as well as others, the present invention seeks to reduce bore distortion, to reduce liner recession, and to accommodate greater dynamic head lifting while more evenly distributing loads circumferentially about the combustion opening. In addition, since the preferred form of a gasket according to the invention has a lower-cost single layer carrier, it significantly reduces load loss resulting from the greater amount of creep caused by multiple layer constructions, as well as eliminating misalignment between multiple layers, tolerance stack up among multiple layers and associated load variations. A preferred form of the inventive gasket allows for carrier embossments that are preselected to have a desired relative flexibility, that provides greater capability to follow relative motion between the members being sealed, and that increases the gasket's ability to accommodate rough mating surfaces of the members over that of prior art multiple layer gaskets. It should be noted that gaskets constructed according to the present invention are applicable in a variety of cylinder head and cylinder block applications, such as those found in internal combustion engines or gas compressors, for example, as well as in intake or exhaust manifold sealing, fuel cell component sealing and numerous other automotive or non-automotive industrial applications.

The present invention provides an improved gasket for sealing between opposed mating surfaces of two or more members having openings therein and that are adapted to be forcibly mated together, continuously or at least intermittently, to clamp the gasket therebetween, thus sealing around such openings, which are laterally aligned for longitudinal communication with each other. A gasket according to the present invention includes a carrier having first and second laterally extending sides or surfaces defining a longitudinal thickness therebetween. The carrier includes a gasket opening (as well as other coolant, lubricant, fastener or other openings, as required in a given application), with the gasket opening being adapted to be laterally aligned in longitudinal communication with the openings in the mating surface of the members when the gasket is clamped between the mated members. The preferred carrier is resiliently flexible in the longitudinal direction, but is relatively rigid in comparison to other elements of the gasket. A resilient sealing material that is substantially more flexible than the carrier material is disposed on at least portions of the laterally extending sides of the carrier for sealingly engaging the mated surfaces of the members at least adjacent their openings when the gasket is clamped between the mated members.

The carrier preferably includes a longitudinally flexible inner sealing portion disposed laterally adjacent the gasket opening with the inner sealing portion being longitudinally offset relative to the remainder of said carrier portion (or relative to an intermediate carrier portion located laterally outward of the inner sealing portion). The inner sealing portion is preferably offset in a longitudinal direction toward a first of the mating surfaces of the members when the gasket is being clamped therebetween and can be formed by way of embossing the relatively rigid (but still resiliently flexible) carrier, as well as by way of other forming methods or devices known to those skilled in the art. The inner sealing portion preferably includes the above-mentioned resilient sealing material disposed on at least portions of its laterally-extending sides for sealing engagement with the mating surfaces of the members when the gasket is clamped therebetween. These carrier features can be formed as embossments, for example, either before or after application of the resilient sealing material.

The preferred carrier also includes a longitudinally flexible stopper portion spaced laterally outwardly, away from the gasket opening so that the inner sealing portion and the flexible stopper portion are on opposite lateral sides of the above-mentioned the intermediate portion, or at least so that the flexible stopper portion is laterally outward relative to the inner sealing portion (i.e., with or without the intermediate carrier portion). The preferred flexible stopper portion is longitudinally convex relative to the remainder of the carrier (or relative to the intermediate carrier portion) on a side of the flexible stopper oriented toward one of the mating surfaces and is longitudinally concave relative to the remainder of the carrier (or relative to the intermediate carrier portion) on an opposite side of the flexible stopper oriented toward another of the mating surfaces of the members. The stopper, which can have a generally trapezoidal shape, for example, thus flexibly and resiliently limits the amount of longitudinal compression of the inner sealing portion but is typically less flexible than the inner sealing portion. The inner sealing portion is thus maintained in sealing engagement with the mating surfaces of both of the members during any relative movement therebetween when the members are mated together.

In a preferred form of the invention, the inner sealing portion is longitudinally offset to an extent greater than the extent of the longitudinal convexity of the flexible stopper so as to assure deflection of the inner sealing portion prior to compression of the flexible stopper. In addition, the resilient sealing material is preferably disposed within, and can completely fill or at least partially fill the concave side of the flexible stopper member. In specific applications, however, it may be satisfactory to optionally omit the resilient sealing from completely filling the concave flexible stopper side altogether in any of the embodiments of the invention.

In any of the gasket embodiments according to the present invention, the inner sealing portion can optionally be longitudinally offset in various configurations, such as a generally “Z-shaped” half-embossment or a inclined or angled partially embossed or bent configuration, for example, as will become readily apparent to those skilled in the art from the drawings and from the following description and claims. Additionally, the inner sealing portion of the carrier, instead of being integrally formed by bending or by embossing as part of the carrier, can optionally be substantially separated from the remainder of the carrier member but interconnected and held in place by two or more connecting struts or by one or more “living hinges” formed of the resilient sealing material. Such living hinge or hinges can be between any pair of, or any combination of, the inner sealing portion, the intermediate carrier portion and/or the flexible stopper. Two or more flexible stoppers can also be optionally included in some or all of the embodiments of the invention, with such multiple flexible stoppers facing in opposite longitudinal directions, facing in the same longitudinal direction, or any combination of such orientations.

It should further be noted that gaskets according to the present invention can be advantageously used in a wide variety of applications, such as cylinder head and block sealing for internal combustion engines, gas compressors, or other devices having a sealed cylinder containing liquid or gaseous fluids, sealing intake, exhaust or other fluid conveying manifold applications, sealing between piping flanges, or sealingly isolating the interior from the exterior of housings or enclosures, for example. The present invention provides special advantages where relative movement can occur between the members being sealed, such as that due to thermal, mechanical or fluid conditions or environments presented by a particular applications. Those skilled in the art will undoubtedly recognize many other advantageous applications of gaskets according to the present invention.

Additional objects, advantages, and features of the present invention will become apparent from the following description and the appended claims, taken in conjunction with the accompanying drawings.

### BRIEF DESCRIPTION OF THE DRAWINGS

FIG. 1 depicts one laterally-extending side of one exemplary preferred gasket according to the present invention, with the gasket being adapted for sealing between a cylinder head and a cylinder block.

FIG. 2 is a partial cross-sectional view, taken along line 2-2 of FIG. 1.

FIG. 3 is a partial cross-sectional view, illustrating the exemplary gasket of FIG. 1 in a partially compressed condition.

FIG. 4 illustrates unloading curves for the exemplary gasket of FIG. 1 and for a typical multiple layer prior art gasket, with load plotted against relative deflection of the mating members, in order to illustrate the invention's improved load retention characteristics.

FIG. 5 is a partially exploded view, illustrating a typical multiple layer prior art gasket.

FIG. 6 is a partially exploded view, similar to FIG. 5, but illustrating the preferred, flexible but relatively rigid, single carrier member of FIG. 1 sandwiched between two layers of the more highly flexible resilient sealing material.

FIGS. 7a and 7b illustrate an example of contact point stress values in opposite directions on opposite mating members during unloading between the mating members for a typical multiple layer prior art gasket.

FIGS. 8a and 8b are similar to FIGS. 7a and 7b, respectively, but illustrating such contact point stress values in opposite directions on opposite mating members during unloading for an exemplary gasket according to the present invention having a single layer carrier.

FIG. 9 is a partial cross-sectional view of an alternate gasket according to the present invention, which is similar to that of FIGS. 1 and 2, except that the flexible stopper portion is coated but not filled with resilient material on its concave side.

FIG. 10 is a partial cross-sectional view, similar to that of FIGS. 2 and 9, but illustrating yet another alternate embodiment of a gasket according to the present invention, wherein the flexible stopper portion has a generally serpentine, “S-shaped” cross-sectional shape, essentially forming multiple flexible stoppers, with the concave portions of the flexible stopper portion alternatively being merely coated with the resilient material or at least partially filled with the resilient material.

FIG. 11 is a partial cross-sectional view similar to that of FIGS. 2, 9 and 10, but illustrating still another alternate embodiment of a gasket according to the present invention, with the inner seal portion extending in a laterally and longitudinally inclined or angled direction, and with the flexible stopper portion being alternately merely coated with the resilient material or at least partially filled with the resilient material.

FIGS. 12a and 12b illustrate a partial perspective view and a partial cross-sectional view, respectively, of another alternate embodiment of the present invention, wherein the inner sealing portion of the carrier is substantially separated from the remainder of the carrier member but interconnected and held in place by two or more connecting struts.

FIGS. 13a and 13b are similar to those of FIGS. 12a and 12b, respectively, but illustrating yet another alternate embodiment of the present invention, wherein the inner sealing portion of the carrier member is separate from the remainder of the carrier member, but with the inner sealing portion and the intermediate carrier portion being interconnected by one or more “living hinge” sections of the resilient material.

FIG. 14 is a partial schematic cross-section, conceptually illustrating other examples of other applications of the present invention.

### DETAILED DESCRIPTION OF THE PREFERRED EMBODIMENTS

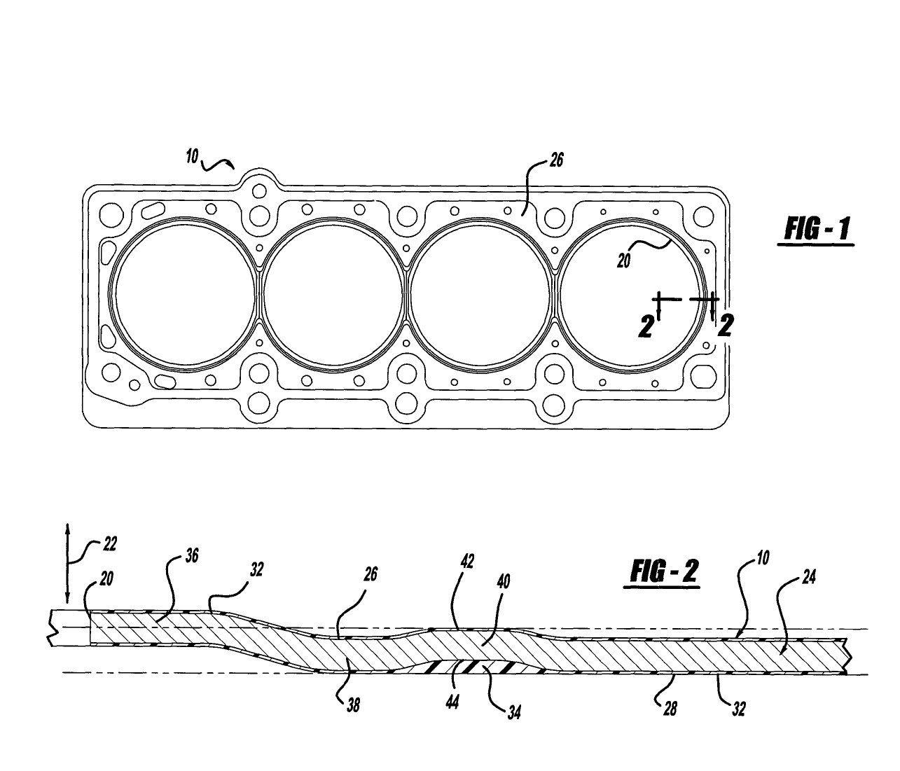

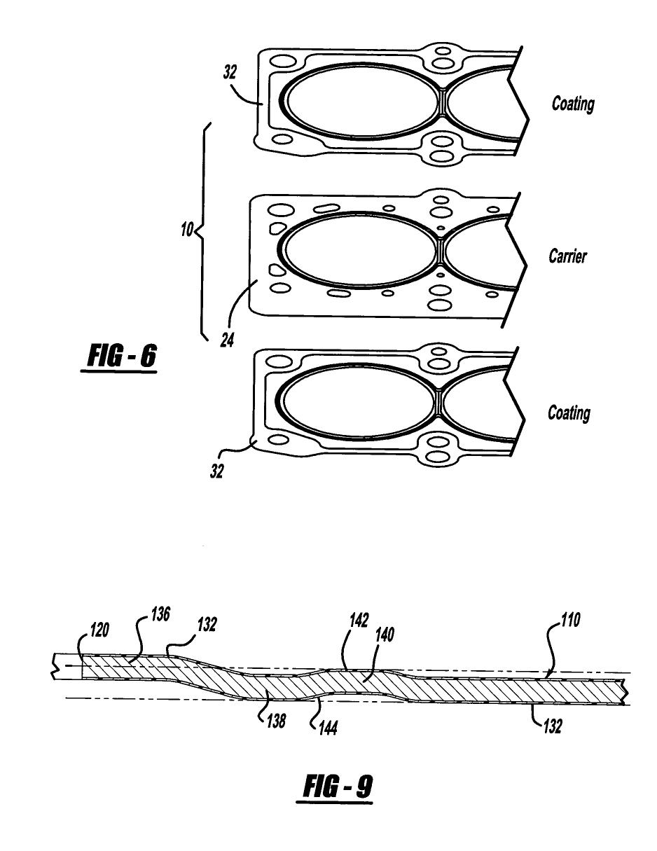

FIGS. 1 through 13 illustrate various embodiments of a gasket according to the present invention. For purposes of example, only, FIGS. 1 through 13 are primarily directed toward a cylinder head gasket for sealing between mating surfaces of a cylinder head and a cylinder block on an internal combustion engine, gas compressor, or other similarly configured device. It should be noted, however, as will become apparent to those skilled in the art from the following description and claims, the principles of the present invention are equally applicable to other devices used in the automotive and non-automotive industrial areas, such as flanged piping components, enclosure or housing seals, piping system manifold seals, or other devices where proper sealing and flexibility is desired between opposed mating surfaces of two or more members, as is illustrated conceptually in FIG. 14.

Referring initially to FIGS. 1 through 4 and 6, one preferred embodiment of the invention is represented by an exemplary gasket 10 for sealing between a mating member 12 and a mating member 14, which are adapted to be matingly clamped together, with the gasket 10 therebetween, such as by bolts or other conventional clamping devices. The mating members 12 and 14 have respective laterally-extending mating surfaces 13 and 15 surrounding respective openings 16 and 18, which are configured for conducting fluids between the members 12 and 14 generally in a longitudinal direction 22.

The gasket 10 of FIG. 1 includes a relatively rigid, but still flexible, carrier 24, laterally-extending gasket sides 26 and 28, a complete coating (or at least a localized coating) of a much more flexible resilient sealing material 32, and a gasket opening 20 adapted to be laterally aligned with the openings 16 and 18 of the members 12 and 14 for longitudinal communication therebetween. The gasket 10 further includes a longitudinally-offset inner sealing portion 36, an intermediate portion 38, and a longitudinally offset flexible stopper 40.

Preferably, exemplary the flexible stopper 40 (which can be characterized as a “full embossment”) is longitudinally offset to a lesser extent than the inner sealing portion 36 (which can similarly be characterized as a “half embossment”). It is important to emphasize that, unlike the more rigid stoppers of prior art gaskets, the flexible stopper 40 is spaced away from the gasket opening 20 (as well as from the mating member openings 16 and 18), with the primary sealing component of the gasket (i.e., the inner sealing portion 36) and the intermediate portion 38 being between the flexible stopper 40 and the gasket opening 20. The flexible stopper 40 preferably has a convex side 42 and a concave side 44, either of which can be oriented toward either of the members 12 or 14. The concave side 44 can optionally be merely coated with the resilient sealing material 32 or partially or completely filled with the resilient sealing material 32. Typically, although not necessarily in a given application, the inner sealing portion 36 is more flexible than the flexible stopper 40.

Examples of materials for the carrier 40 can include semi-rigid synthetic or natural materials, metals or non-metals, with one example being composed of 301 stainless spring steel, full-hard, 0.3 mm thick (approximately 0.002 mm to 0.005 mm, or even wider ranges of thicknesses may be used in given applications). Lower hardnesses of steel or other metals can of course also be used if a reduction in spring force is desired in a particular application. However, such softer materials may, over time, exhibit a decrease in recovery performance during unloading conditions, such as those resulting from relative movement between the mating members. Other metals or metal alloys may also have application in the present invention, such as hardened carbon steel, inconel, titanium, or still others known to those skilled in the art.

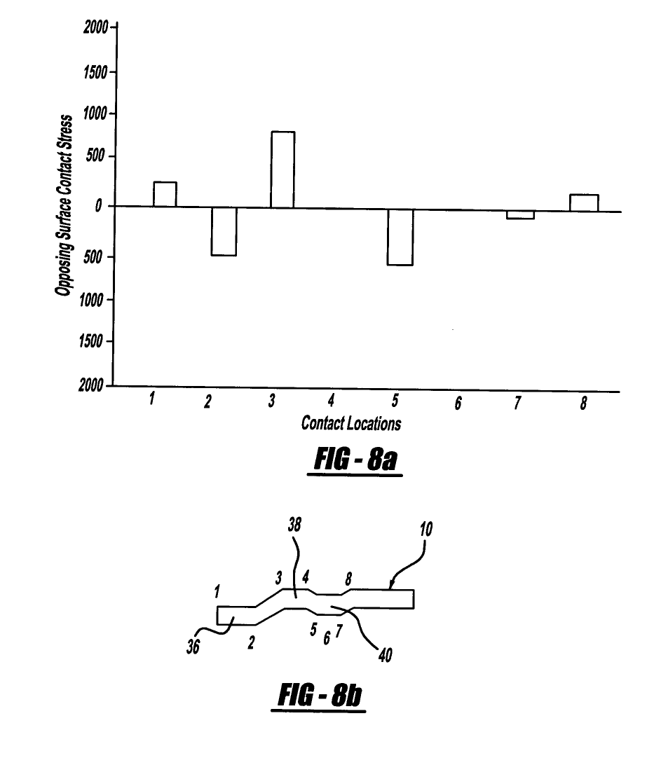

Examples of materials for the resilient sealing material 32 in the illustrated example can include those that are applied to the carrier material prior to forming the carrier itself, those coated onto the carrier after it is formed, or even localized coating only in desired areas, such as those adjacent the gasket opening 20 or other areas adjacent fluid openings (e.g., for lubricant, for cooling, etc.), bolt holes, or the like. Such resilient sealing material 32 is preferably on at least both sides of any or all of the inner sealing portion 36, the intermediate portion 24, or the flexible stopper 40. If desired to be applied only in localized areas of the gasket 20, resilient sealing material 32 can be applied in a variety of different ways, such as by screen printing, for example. In this regard, it should also be noted that the concave side 44 of the flexible stopper 40 can be merely coated (as in the concave side 144 on the stopper 140 shown in FIG. 9) or partially or completely filled with the resilient sealing material 32, either locally or as part of a larger or even an overall coating of the carrier 24. In one form of the invention, the preferred resilient sealing material is FKM, having a thickness of approximately 0.0002 inch to approximately 0.003 inch, although a much wider range of thicknesses can be used, as required or desirable in a particular application. Other resilient and conformable materials may also be suitable in any of a wide variety of applications, such as nitrile or silicone, for example.

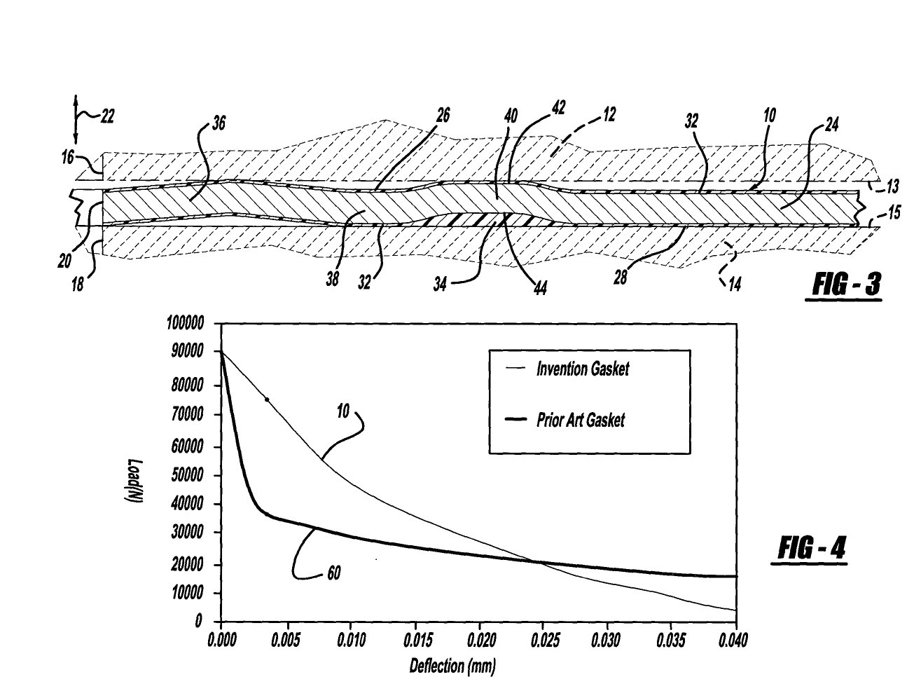

In FIG. 3, the gasket 10 is shown partially compressed between the members 12 and 14. In this condition, as well as in other more fully compressed conditions, the inner sealing portion 36 typically deflects first and provides the primary sealing about the openings 16, 18 and 20. The flexible stopper 40, being typically les flexible than the inner sealing portion 36, limits the amount of compression or deflection of the inner sealing portion 36, but it performs this function flexibly, unlike the much more rigid stoppers of prior art gaskets. This allows the gasket to provide more effective, repeatable and reliable sealing between the members 12 and 14, especially during lower load conditions, such as those resulting from relative movement between the members 12 and 14 due to compression, combustion, exhaust, or other varying pressures.

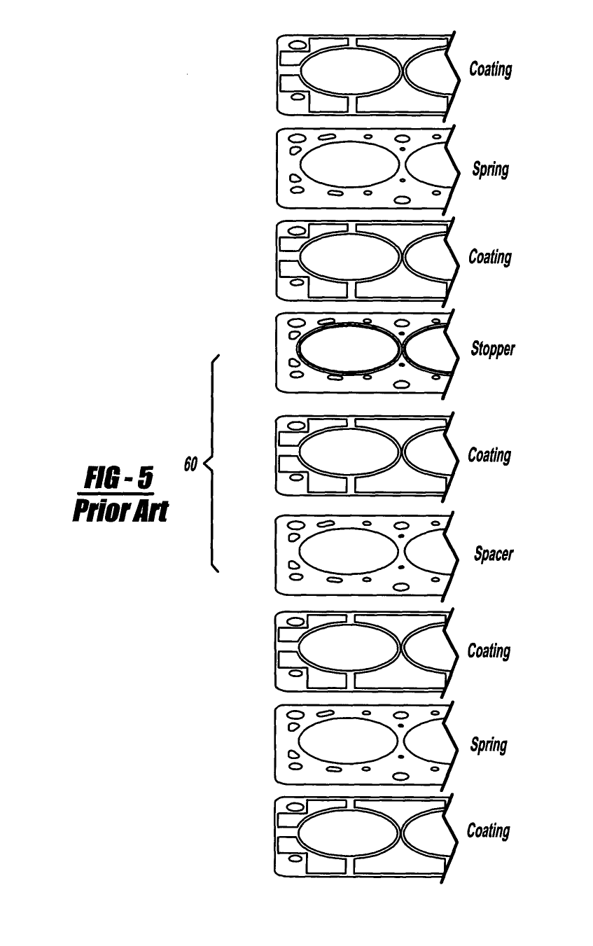

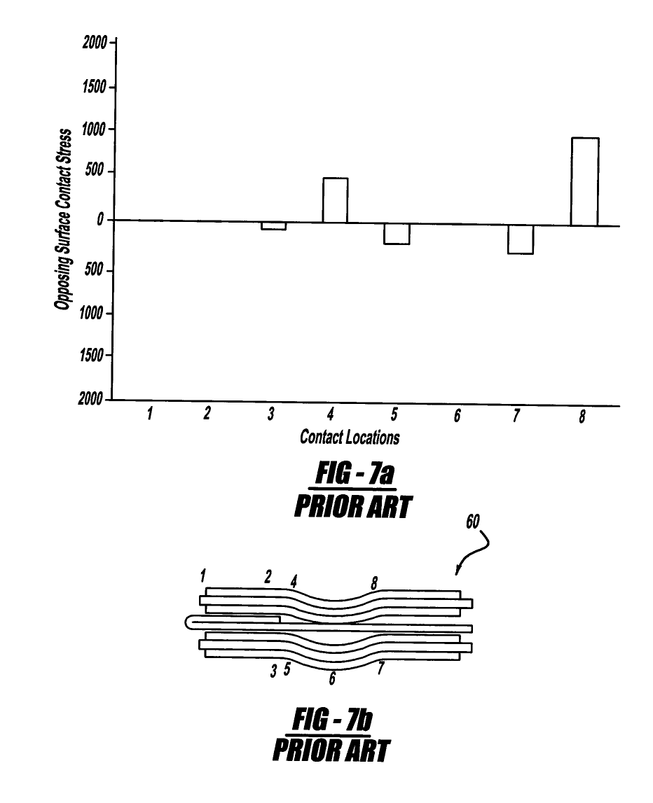

This advantage is further illustrated in FIG. 4, wherein the invention is capable of higher (and thus more leak-proof) sealing loadings than is a typical multiple layer gasket of the prior art, such as that illustrated in FIG. 5, for example, throughout design operating ranges. This advantageous comparison is also evident from FIGS. 7a and 7b (prior art) and FIGS. 8a and 8b, wherein the contact stresses on the opposed mating surfaces of the mating members (e.g., surfaces 13 and 15 on members 12 and 14, for example) are graphically represented at various location 1 through 8 on the mating surfaces.

Again referring to FIG. 5, it is also important to note that such multiple layer prior art gaskets, such as the gasket 60, require sealing material on both sides of each layer, with the multiple and separately coated layers significantly adding to their cost, as well as presenting the other disadvantages discussed above.

FIGS. 10 through 14 illustrate other alternate constructions or embodiments, with the reference numerals in FIGS. 10 through 14 indicating similar or corresponding elements to those of FIGS. 1 through 9, but with two-hundred through six hundred prefixes, respectively.

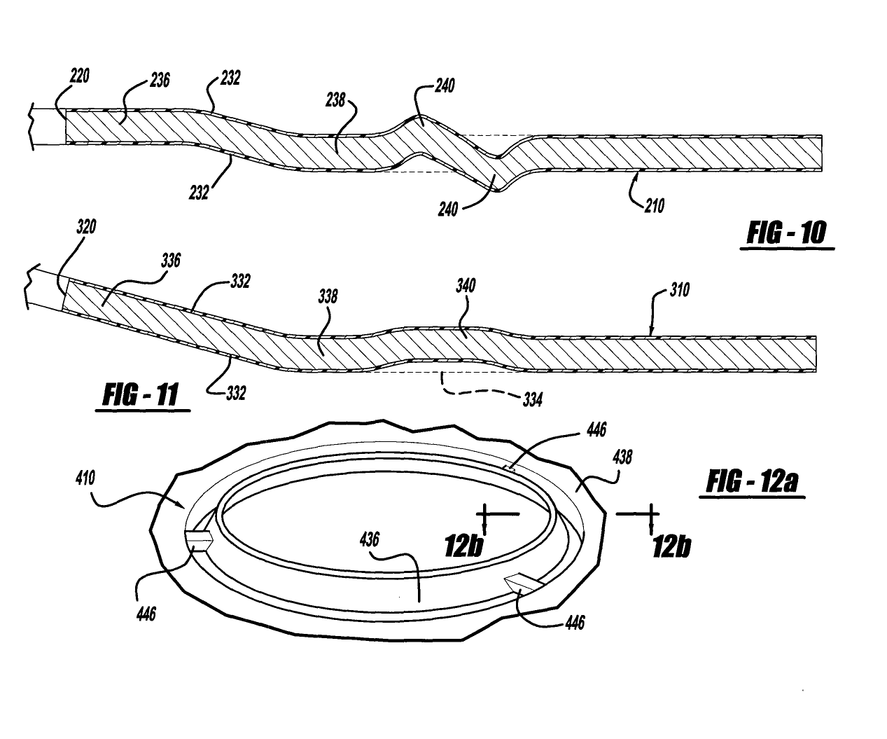

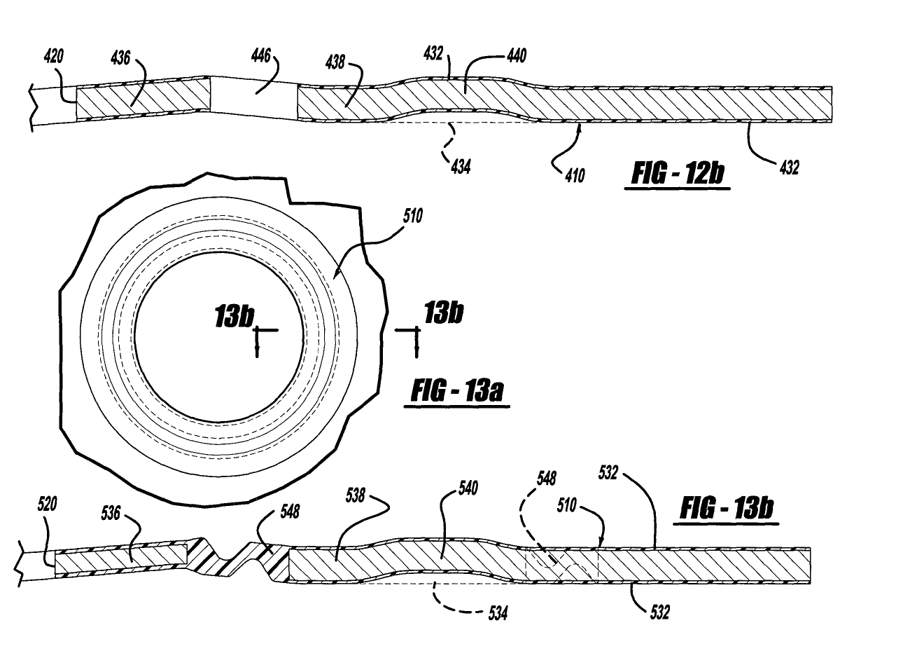

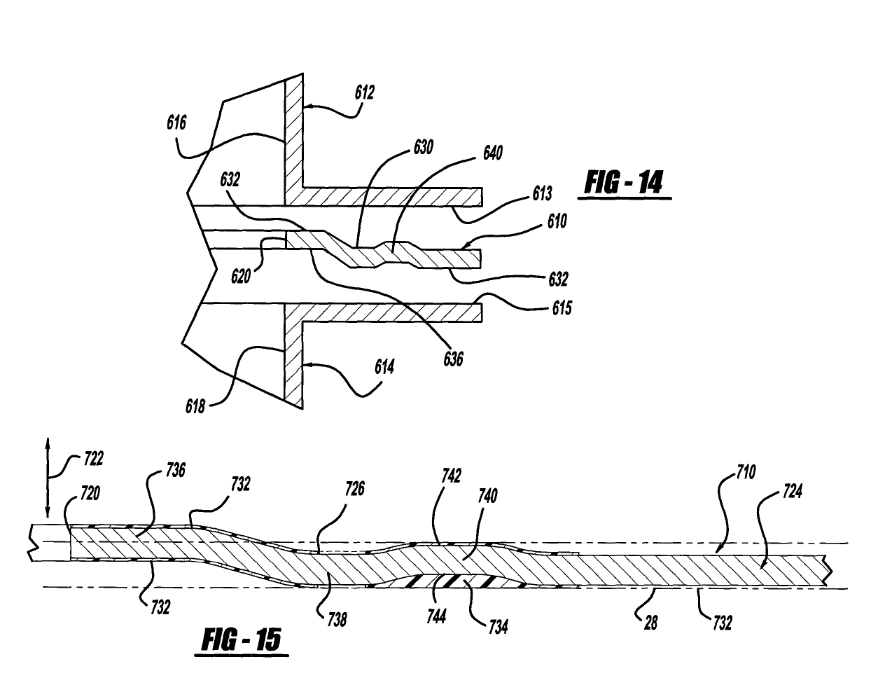

FIG. 10 illustrates a gasket 210, a generally serpentine flexible stopper 240, effectively forming a number of flexible stopper portions 240. In FIG. 11, the inner sealing portion 336 is longitudinally offset in an inclined or angled direction. FIGS. 12a and 12b illustrate a separated inner sealing portion 436 interconnected with the remainder of the gasket 410 and held in its proper position by one or more struts 446. Similarly, in FIGS. 13a and 13b, a separated inner sealing portion 536 is interconnected with the remainder of the gasket 510 and held in its proper position by one or more “living hinge” portions 536 of the resilient sealing material 532. It should be noted that this construction also allows for different thicknesses of the inner sealing portion 536 and the remainder of the gasket 510 (with either of them being thicker or thinner than the other) in order to obtain particular deformation and load retention characteristics in a given application.

FIG. 14 schematically illustrates, in conceptual form, the use of a gasket 610 according to the present invention in a wide variety of applications, with the gasket 610 having any or any combination of the features, shapes or characteristics discussed above in connection with FIGS. 1 through 13. The members 612 can be flanges or other portions of any of numerous devices or structures, such as intake, exhaust or other manifolds, piping or other fluid-conveying devices, gas compression or other high pressure constructions, sealed housings or enclosures, or other sealing applications known to those skilled in the art. As mentioned above, the invention is especially advantageous where relative movement can occur between the members being sealed, such as that caused by thermal, mechanical or fluid conditions or environments presented by a particular applications.

The foregoing discussion discloses and describes merely exemplary embodiments of the present invention for purposes of illustration only. One skilled in the art will readily recognize from such discussion, and from the accompanying drawings and claims, that various changes, modifications and variations can be made therein without departing from the spirit and scope of the invention as defined in the following claims.

1. An improved gasket for sealing between longitudinally opposed mating surfaces of at least a pair of members adapted to be forcibly mated together to clamp said gasket therebetween, the mating surfaces having openings therein laterally aligned in longitudinal communication with each other when the members are mated together, said gasket comprising:
a relatively rigid carrier having first and second laterally-extending sides defining a longitudinal thickness therebetween, said carrier having at least one gasket opening therethrough adapted to be laterally aligned in longitudinal communication with the openings in the mating surfaces of the members when said gasket is clamped between the mated members;
a resilient sealing material substantially more flexible than said carrier and being disposed on at least portions of said laterally-extending sides of said carrier for sealingly engaging the mating surfaces of the members adjacent the openings therein when said gasket is clamped between the mated members;
a longitudinally flexible inner sealing portion of said carrier disposed laterally adjacent and substantially defining the periphery of said gasket opening, said inner sealing portion being longitudinally offset relative to the remainder of the carrier, said inner sealing portion being offset in a longitudinal direction toward a first of the members when said gasket is clamped between the mated members, said inner sealing portion having said resilient sealing material disposed on at least portions of its laterally-extending sides for sealing engagement with the mating surfaces of the members when said gasket is clamped between the mated members; and
a longitudinally flexible outer stopper portion of said carrier spaced laterally away from said gasket opening and disposed laterally outward relative to said inner sealing portion, said flexible outer stopper portion and said inner sealing portion being in close lateral proximity with each other and in close lateral proximity with the same said gasket opening, said flexible stopper portion being longitudinally convex relative to the remainder of said carrier on a side of said flexible stopper oriented toward said first of the members and being longitudinally concave relative to the remainder of said carrier on an opposite side of said flexible stopper oriented toward a second of the members, said flexible stopper acting in conjunction with said inner sealing portion and with respect to the same said gasket opening to flexibly limit the amount of longitudinal compression of said inner sealing portion and being less flexible than said inner sealing portion, said inner sealing portion being thereby maintained in said sealing engagement with the mating surfaces of both of the members during relative movement between the members when the members are mated together.

2. The gasket of claim 1, wherein said inner sealing portion is longitudinally offset to an extent greater than the extent of longitudinal convexity of the flexible stopper portion.

3. The gasket of claim 1, wherein said inner sealing portion has a lateral dimension greater than the lateral dimension of said flexible stopper.

4. The gasket of claim 1, wherein said flexible stopper member has said resilient sealing material disposed within and at least partially filling its concave side toward said second of the members when said gasket is clamped between the mated members.

5. The gasket of claim 1, wherein said flexible stopper has said resilient sealing material disposed on at least portions of its laterally-extending sides for sealing engagement with the mating surfaces of the members when said gasket is clamped between the mated members.

6. The gasket of claim 1, wherein said flexible stopper member has an additional amount of said resilient sealing material disposed within and at least partially filling its concave side toward said second of the members.

7. The gasket of claim 1, wherein said relatively rigid carrier is a single layer carrier.

8. The gasket of claim 1, wherein said carrier is formed of a metal-containing material.

9. The gasket of claim 1, wherein said carrier is formed of a steel-containing material.

10. The gasket of claim 1, wherein said carrier is formed of a synthetic-containing material.

11. The gasket of claim 1, wherein said resilient sealing material is a rubber-containing material.

12. The gasket of claim 1, wherein said resilient sealing material is an elastomer-containing material.

13. The gasket of claim 1, wherein said resilient sealing material covers substantially all of said laterally-extending sides of said carrier.

14. The gasket of claim 1, wherein said resilient sealing material is adjacent at least portions of said carrier.

15. The gasket of claim 1, wherein said resilient sealing material is screen-printed onto at least portions of said carrier.

16. The gasket of claim 1, wherein said gasket is adapted to be clamped between a cylinder head and a cylinder block of an internal combustion engine.

17. The gasket of claim 1, wherein said gasket is adapted to be clamped between a cylinder head and a cylinder block of a gas compressor.

18. The gasket of claim 1, wherein said gasket is adapted to be clamped between mated flanges of a gaseous fluid-conveying device.

19. The gasket of claim 1, wherein said gasket is adapted to be clamped between mated flanges of a liquid fluid-conveying device.

20. The gasket of claim 1, wherein said gasket is adapted to be clamped between mated pipe flanges.

21. The gasket of claim 1, wherein said gasket is adapted to be clamped between mated manifold flanges.

22. The gasket of claim 1, wherein said gasket is adapted to be clamped between mating surfaces of members defining an interior of an enclosure for sealingly isolating said enclosure interior from an exterior of said enclosure.

23. The gasket of claim 1, wherein said gasket is adapted to be clamped between mating surfaces of members that are releasably mated together.

24. The gasket of claim 1, wherein said gasket is adapted to be clamped between mating surfaces of members that are intermittently mated together.

25. The gasket of claim 1, wherein at least portions of said carrier are separated but interconnected by a portion of said resilient sealing material.

26. The gasket of claim 1, wherein the mating members are components of a fuel cell.

27. An improved cylinder head gasket for an internal combustion engine having a cylinder head and a cylinder block, said gasket adapted for sealing between longitudinally opposed mating surfaces of the head and the block which are adapted to be forcibly mated together to clamp said gasket therebetween, the mating surfaces having openings therein laterally aligned in longitudinal communication with each other when the head and the block are mated together, said gasket comprising:
a relatively rigid metallic carrier having first and second laterally-extending sides defining a longitudinal thickness therebetween, said carrier having at least one gasket opening therethrough adapted to be laterally aligned in longitudinal communication with the openings in the mating surfaces of the head and the block when said gasket is clamped between the mated head and block;
a resilient sealing material substantially more flexible than said carrier and being disposed on at least portions of said laterally-extending sides of said carrier for sealingly engaging the mating surfaces of the head and the block adjacent the openings therein when said gasket is clamped between the mated head and block;
a longitudinally flexible inner sealing portion of said carrier disposed laterally adjacent said gasket opening and substantially defining the periphery of, said inner sealing portion being longitudinally offset relative to the remainder of said carrier portion, said inner sealing portion being offset in a longitudinal direction toward a first of the head and the block when said gasket is clamped between the mated head and block, said inner sealing portion having said resilient sealing material disposed on at least portions of its laterally-extending sides for sealing engagement with the mating surfaces of the head and the block when said gasket is clamped between the mated head and block; and
a longitudinally flexible outer stopper portion of said carrier spaced laterally away from said gasket opening and disposed laterally outward relative to said inner sealing portion said flexible outer stopper portion and said inner sealing portion being in close lateral proximity with each other and in close lateral proximity with the same said gasket opening, said flexible stopper portion being longitudinally convex relative to the remainder of said carrier portion on a side of said flexible stopper oriented toward said first of the head and the block and being longitudinally concave relative to the remainder of said carrier portion on an opposite side of said flexible stopper oriented toward a second of the head and the block, said flexible stopper member having said resilient sealing material disposed within and at least partially filling its concave side toward said second of the head and the block when said gasket is clamped between the mated head and block, said flexible stopper acting in conjunction with said inner sealing portion and with respect to the same said gasket opening to flexibly limit the amount of longitudinal compression of said inner sealing portion and being less flexible than said inner sealing portion, said inner sealing portion being thereby maintained in said sealing engagement with the mating surfaces of both of the head and the block during relative movement between the head and the block when the head and the block are mated together.

28. The gasket of claim 27, wherein said inner sealing portion is longitudinally offset to an extent greater than the extent of longitudinal convexity of the flexible stopper portion.

29. The gasket of claim 27, wherein said inner sealing portion has a lateral dimension greater than the lateral dimension of said flexible stopper.

30. The gasket of claim 27, wherein said flexible stopper has said resilient sealing material disposed on at least portions of its laterally-extending sides for sealing engagement with the mating surfaces of the head and the block when said gasket is clamped between the mated head and block.

31. The gasket of claim 27, wherein said relatively rigid carrier is a single layer carrier.

32. The gasket of claim 27, wherein said carrier is formed of a steel-containing material.

33. The gasket of claim 27, wherein said resilient sealing material is a rubber-containing material.

34. The gasket of claim 27, wherein said resilient sealing material is an elastomer-containing material.

35. The gasket of claim 27, wherein said resilient sealing material covers substantially all of said laterally-extending sides of said carrier.

36. The gasket of claim 27, wherein said resilient sealing material covers at least portions of said carrier.

37. The gasket of claim 27, wherein said resilient sealing material is screen-printed onto at least portions of said carrier.

38. The gasket of claim 27, wherein at least portions of said carrier are separated but interconnected by a portion of said resilient sealing material.

39. An improved intake manifold gasket for an internal combustion engine having a cylinder head and an intake manifold, said gasket adapted for sealing between longitudinally opposed mating surfaces of the head and the manifold which are adapted to be forcibly mated together to clamp said gasket therebetween, the mating surfaces having openings therein laterally aligned in longitudinal communication with each other when the head and the manifold are mated together, said gasket comprising:
a relatively rigid metallic carrier having first and second laterally-extending sides defining a longitudinal thickness therebetween, said carrier having at least one gasket opening therethrough adapted to be laterally aligned in longitudinal communication with the openings in the mating surfaces of the head and the manifold when said gasket is clamped between the mated head and manifold;
a resilient sealing material substantially more flexible than said carrier and being disposed on at least portions of said laterally-extending sides of said carrier for sealingly engaging the mating surfaces of the head and the manifold adjacent the openings therein when said gasket is clamped between the mated head and manifold;
a longitudinally flexible inner sealing portion of said carrier disposed laterally adjacent and substantially defining the periphery of said gasket opening, said inner sealing portion being longitudinally offset relative to the remainder of said carrier, said inner sealing portion being offset in a longitudinal direction toward a first of the head and the manifold when said gasket is clamped between the mated head and manifold, said inner sealing portion having said resilient sealing material disposed on at least portions of its laterally-extending sides for sealing engagement with the mating surfaces of the head and the manifold when said gasket is clamped between the mated head and manifold; and
a longitudinally flexible outer stopper portion of said carrier spaced laterally away from said gasket opening and disposed laterally outward relative to said inner sealing portion said flexible outer stopper portion and said inner sealing portion being in close lateral proximity with each other and in close lateral proximity with the same said gasket opening, said flexible stopper portion being longitudinally convex relative to the remainder of said carrier portion on a side of said flexible stopper oriented toward said first of the head and the manifold and being longitudinally concave relative to said carrier portion on an opposite side of said flexible stopper oriented toward a second of the head and the manifold, said flexible stopper acting in conjunction with said inner sealing portion and with respect to the same said gasket opening to flexibly limit the amount of longitudinal compression of said inner sealing portion and being less flexible than said inner sealing portion, said inner sealing portion being thereby maintained in said sealing engagement with the mating surfaces of both of the head and the manifold during relative movement between the head and the manifold when the head and the manifold are mated together.

40. The gasket of claim 39, wherein said inner sealing portion is longitudinally offset to an extent greater than the extent of longitudinal convexity of the flexible stopper portion.

41. The gasket of claim 39, wherein said inner sealing portion has a lateral dimension greater than the lateral dimension of said flexible stopper.

42. The gasket of claim 39, wherein said flexible stopper member has said resilient sealing material disposed within and at least partially filling its concave side toward said second of the head and the manifold when said gasket is clamped between the mated head and manifold.

43. The gasket of claim 39, wherein said flexible stopper has said resilient sealing material disposed on at least portions of its laterally-extending sides for sealing engagement with the mating surfaces of the head and the manifold when said gasket is clamped between the mated head and manifold.

44. The gasket of claim 39, wherein said flexible stopper member has an additional amount of said resilient sealing material disposed within and at least partially filling its concave side toward said second of the head and the manifold.

45. The gasket of claim 39, wherein said relatively rigid carrier is a single layer carrier.

46. The gasket of claim 39, wherein said carrier is formed of a steel-containing material.

47. The gasket of claim 39, wherein said resilient sealing material is a rubber-containing material.

48. The gasket of claim 39, wherein said resilient sealing material is an elastomer-containing material.

49. The gasket of claim 39, wherein said resilient sealing material covers substantially all of said laterally-extending sides of said carrier.

50. The gasket of claim 39, wherein said resilient sealing material covers at least portions of said carrier.

51. The gasket of claim 39, wherein said resilient sealing material is screen-printed onto at least portions of said carrier.

52. The gasket of claim 39, wherein at least portions of said carrier are separated but interconnected by a portion of said resilient sealing material.

53. An improved exhaust manifold gasket for an internal combustion engine having a cylinder head and an exhaust manifold, said gasket adapted for sealing between longitudinally opposed mating surfaces of the head and the manifold which are adapted to be forcibly mated together to clamp said gasket therebetween, the mating surfaces having openings therein laterally aligned in longitudinal communication with each other when the head and the manifold are mated together, said gasket comprising:
a relatively rigid metallic carrier having first and second laterally-extending sides defining a longitudinal thickness therebetween, said carrier having at least one gasket opening therethrough adapted to be laterally aligned in longitudinal communication with the openings in the mating surfaces of the head and the manifold when said gasket is clamped between the mated head and manifold;
a resilient sealing material substantially more flexible than said carrier and being disposed on at least portions of said laterally-extending sides of said carrier for sealingly engaging the mating surfaces of the head and the manifold adjacent the openings therein when said gasket is clamped between the mated head and manifold;
a longitudinally flexible inner sealing portion of said carrier disposed laterally adjacent and substantially defining the periphery of said gasket opening, said inner sealing portion being longitudinally offset relative to the remainder of said carrier, said inner sealing portion being offset in a longitudinal direction toward a first of the head and the manifold when said gasket is clamped between the mated head and manifold, said inner sealing portion having said resilient sealing material disposed on at least portions of its laterally-extending sides for sealing engagement with the mating surfaces of the head and the manifold when said gasket is clamped between the mated head and manifold; and
a longitudinally flexible outer stopper portion of said carrier spaced laterally away from said gasket opening and disposed laterally outward relative to said inner sealing portion said flexible outer stopper portion and said inner sealing portion being in close lateral proximity with each other and in close lateral proximity with the same said gasket opening, said flexible stopper portion being longitudinally convex relative to the remainder of said carrier portion on a side of said flexible stopper oriented toward said first of the head and the manifold and being longitudinally concave relative to the remainder of said carrier portion on an opposite side of said flexible stopper oriented toward a second of the head and the manifold, said flexible stopper flexibly limiting acting in conjunction with said inner sealing portion and with respect to the same said gasket opening to flexibly limit the amount of longitudinal compression of said inner sealing portion and being less flexible than said inner sealing portion, said inner sealing portion being thereby maintained in said sealing engagement with the mating surfaces of both of the head and the manifold during relative movement between the head and the manifold when the head and the manifold are mated together.

54. The gasket of claim 53, wherein said inner sealing portion is longitudinally offset to an extent greater than the extent of longitudinal convexity of the flexible stopper portion.

55. The gasket of claim 53, wherein said inner sealing portion has a lateral dimension greater than the lateral dimension of said flexible stopper.

56. The gasket of claim 53, wherein said flexible stopper member has said resilient sealing material disposed within and at least partially filling its concave side toward said second of the head and the manifold when said gasket is clamped between the mated head and manifold.

57. The gasket of claim 53, wherein said flexible stopper has said resilient sealing material disposed on at least portions of its laterally-extending sides for sealing engagement with the mating surfaces of the head and the manifold when said gasket is clamped between the mated head and manifold.

58. The gasket of claim 53, wherein said flexible stopper member has an additional amount of said resilient sealing material disposed within and at least partially filling its concave side toward said second of the head and the manifold.

59. The gasket of claim 53, wherein said relatively rigid carrier is a single layer carrier.

60. The gasket of claim 53, wherein said carrier is formed of a steel-containing material.

61. The gasket of claim 53, wherein said resilient sealing material is a rubber-containing material.

62. The gasket of claim 53, wherein said resilient sealing material is an elastomer-containing material.

63. The gasket of claim 53, wherein said resilient sealing material covers substantially all of said laterally-extending sides of said carrier.

64. The gasket of claim 53, wherein said resilient sealing material covers at least portions of said carrier.

65. The gasket of claim 53, wherein said resilient sealing material is screen-printed onto at least portions of said carrier.

66. The gasket of claim 53, wherein at least portions of said carrier are separated but interconnected by a portion of said resilient sealing material.

67. An improved gasket for sealing between longitudinally opposed mating surfaces of at least a pair of members adapted to be forcibly mated together to clamp said gasket therebetween, the mating surfaces having openings therein laterally aligned in longitudinal communication with each other when the members are mated together, said gasket comprising:
a relatively rigid carrier having first and second laterally-extending sides defining a longitudinal thickness therebetween, said carrier having at least one gasket opening therethrough adapted to be laterally aligned in longitudinal communication with the openings in the mating surfaces of the members when said gasket is clamped between the mated members;
a longitudinally flexible inner sealing portion of said carrier disposed laterally adjacent and substantially defining the periphery of said gasket opening, said inner sealing portion being longitudinally offset relative to the remainder of the carrier, said inner sealing portion being offset in a longitudinal direction toward a first of the members when said gasket is clamped between the mated members; and
a longitudinally flexible outer stopper portion of said carrier spaced laterally away from said gasket opening and disposed laterally outward relative to said inner sealing portion said flexible outer stopper portion and said inner sealing portion being in close lateral proximity with each other and in close lateral proximity with the same said gasket opening, said flexible stopper portion being longitudinally convex relative to the remainder of said carrier on a side of said flexible stopper oriented toward said first of the members and being longitudinally concave relative to the remainder of said carrier on an opposite side of said flexible stopper oriented toward a second of the members, said flexible stopper flexibly limiting acting in conjunction with said inner sealing portion and with respect to the same said gasket opening to flexibly limit the amount of longitudinal compression of said inner sealing portion and being less flexible than said inner sealing portion, said inner sealing portion being thereby maintained in said sealing engagement with the mating surfaces of both of the members during relative movement between the members when the members are mated together.

68. The gasket of claim 67, further including a resilient sealing material substantially more flexible than said carrier and being disposed on at least portions of said laterally-extending sides of said carrier for sealingly engaging the mating surfaces of the members adjacent the openings therein when said gasket is clamped between the mated members, said inner sealing portion having said resilient sealing material disposed on at least portions of its laterally-extending sides for sealing engagement with the mating surfaces of the members when said gasket is clamped between the mated members.

69. The gasket of claim 1, wherein said flexible stopper member is the sole stopper with respect to said same gasket opening.

70. The gasket of claim 27, wherein said flexible stopper member is the sole stopper with respect to said same gasket opening.

71. The gasket of claim 39, wherein said flexible stopper member is the sole stopper with respect to said same gasket opening.

72. The gasket of claim 53, wherein said flexible stopper member is the sole stopper with respect to said same gasket opening.

73. The gasket of claim 67, wherein said flexible stopper member is the sole stopper with respect to said same gasket opening.
